(19) United States
(12) Patent Application Publication
(10) Pub. No.: US 2007/0263049 A1
(43) Pub. Date: Nov. 15, 2007

(54) Supply arrangement with supply reservoir element and microfluidic device

(76) Inventors: Tobias Preckel, Marxzell (DE); Hans-Peter Zimmermann, Waldbronn (DE); Konstantin Choikhet, Karlsruhe (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/804,093

(22) Filed: May 17, 2007

(30) Foreign Application Priority Data
Nov. 17, 2004 (EP) PCT/EP04/52985

(51) Int. Cl. B41J 2/175

(52) U.S. Cl. 347/85

(57) ABSTRACT

A supply arrangement includes a supply reservoir element and a microfluidic device, wherein the supply reservoir element has a first reservoir unit having a prefilled liquid reagent therein, and the microfluidic device has a reception device adapted for receiving the liquid reagent from the first reservoir unit. The supply reservoir element is coupled to the microfluidic device. One of the supply reservoir element and the microfluidic device includes a puncturing element in order to cause fluid flow of the liquid reagent from the first reservoir unit to the reception device when the puncturing element is operated. The supply reservoir element has a basal plane, and the first reservoir unit has a first blister element arranged on the basal plane.

### BACKGROUND ART

The present invention relates to fluidic devices.

For a couple of years the analytical and chemical instruments fabricating industry manufactures small dimensions of chemical and biochemical apparatus in response to the demand of scientist's request to provide them with systems of miniaturized sizes. Those miniaturized systems require small volumes of the agents, respectively samples and solvents, which is an important advantage when the sample material is rare and/or expensive. Science is still aiming for apparatus and instruments helping to improve the performance of synthesis and analysis with respect to an efficient time/money to product ratio.

Microfluidic devices are in particular useful for applications performing the parallel or simultaneous examination of a number of fluidic substance specimens, which become organized and arranged on microtiter plates or so-called “well plates”. The specimens to be examined being contained in fluidic samples which are filled in small cavities, the “wells”, which are generally arranged in a matrix pattern. Such well plates are known, for example, from U.S. Pat. No. 5,457,527, WO 97/122754 and WO 95/03538. Injecting of the fluidic samples into the plurality of wells can be done manually or automatically by means of an automatic dispensing device.

In order to initiate or to carry out the desired process, it may now be necessary to add a definite volume of reagents or substances to each of the substance specimens. Adding of these reagents or substances can be performed manually by use of a pipette or dispenser, which is very time spending and which requires furthermore very careful handling.

From U.S. Pat. No. 2001/0008613 to Kaltenbach et al. it is known to couple operatively modularly a reservoir unit with the separation unit of a micro channel apparatus for analysis. The reservoir unit contains repacked liquid reagents to supply the separation unit with.

Another supply element is referred to in DE 19928412 C2 to Berndt, Manfred. Herein the supply element is designed as a separate module which can be combined with a microchip, providing an electronic passage, permitting transition of the supply reagent at the moment of coupling.

### DISCLOSURE OF THE INVENTION

It is an object of the present invention to provide an improved fluidic device. The object is solved by the independent claims. Preferred embodiments are shown by the dependent claims.

Generally, the present invention addresses the aforementioned needs in the art and depicts arrangements combining a supply reservoir element with a fluidic device. The supply reservoir element is prepared and prefilled with liquid reagents and supplies the fluidic device in due course of time.

Embodiments of the invention show fluidic devices, in particular microfluidic devices to carry out a desired chemical, physical or biological process, such as a separation process for example. The process requires adding of definite volumes of definite reagents, which can be added easily by arranging a supply reservoir element above the fluidic or microfluidic element, wherein a fluid flow from the supply reservoir element is induced at a desired time. These embodiments refer substantially to a fluidic or microfluidic element with a supply reservoir element arranged above, additionally comprising means to provide a fluidic communication directed from the supply reservoir element to the microfluidic element or its reception devices, respectively.

The means to provide a fluidic communication may be designed in different ways, accordingly leading to different further embodiments.

Further embodiments are an extension of the above embodiments, comprising a holding fixture which holds the arrangement of fluidic or microfluidic element and supply reservoir element which is prefilled with liquid reagents, the arrangement being provided with a puncturing element, thus constituting a supply kit. Again, different embodiments of the supply kit result from the choice of the puncturing element. In any embodiment of the supply kit the user is allowed to operate the puncturing element through the material of the holding fixture, independent of the design of the puncturing element.

Providing the user with readily prepared devices for carrying out chemical and biological processes such as separation of proteins, in particular providing the user with perfectly conditioned volumes of liquid reagents or reagents ready to mix saves a lot of time for the user and permits him to optimize his efficiency in lab work, in particular with respect to the use of costly detection apparatuses. Furthermore, the use of prefilled reagents prevents the user from making errors during the otherwise necessary steps of pipetting the reagents into the reception devices such as caddies of microfluidic chips.

### BRIEF DESCRIPTION OF DRAWINGS

Other objects and many of the attendant advantages of embodiments of the present invention will be readily appreciated and become better understood by reference to the following more detailed description of preferred embodiments in connection with the accompanied drawings. Features that are substantially or functionally equal or similar will be referred to with the same reference signs. The Figures show:

FIG.1 a side view of a supply reservoir element, comprising two reservoir units being linked by a channel,

FIG. 1a a side view of the cross sectional area of the channel shown in FIG.1,

FIG. 2 a top view of the supply reservoir of FIG. 1,

FIG. 3 a side view of a the supply reservoir of FIG. 1, mixing of reagents contained by the reservoir units being in process,

FIG. 4 a side view of a supply kit comprising an arrangement of a fluidic device and a supply reservoir element with a puncturing element including a cannula between them,

FIG. 5 a top view of a the cannula shown in FIG. 4,

FIG. 6 a side view of the supply kit of FIG. 4 with the puncturing element being operated and the fluid flow being in process,

FIG. 7 a side view of a supply kit comprising an arrangement of a fluidic device and a supply reservoir element with a puncturing element being part of the supply unit, which is designed as a blister element,

FIG. 8 a side view of the supply kit of FIG. 7 with the puncturing element being operated,

FIG. 9 a side view of the supply kit of FIG. 8 after the puncturing element having been operated and the fluid flow being in process.

### DETAILED DESCRIPTION OF DRAWINGS

Before the invention is described in detail, it is to be understood that this invention is not limited to the particular component parts of the devices described or to process steps of the methods described as such devices and methods may vary. It is also to be understood, that the terminology used herein is for purposes describing particular embodiments only and it is not intended to be limiting. It must be noted that, as used in the specification and the appended claims, the singular forms of “a”, “an”, and “the” include plural referents until the context clearly dictates otherwise. Thus, for example, the reference to “a blister element” may include two or more such blister elements; “punch needle” or “the” may as well include two or more such punch needles where it is reasonable in the sense of the present invention.

In this specification and in the claims which follow, reference will be made to the following terms which shall be defined to have the herewith explained meanings:

The term “fluidic device” is used herein to refer to any column devices or devices comprising channels for separation or preparative purposes and the like as used in chemical, biochemical or biochemical lab applications.

The term “microfluidic device” or “chip” is referring accordingly to the miniaturized versions of fluidic devices.

The meaning of a “supply reservoir element” is an element which is designed to contain a definite volume of a liquid reagent in order to provide a fluidic device with the reagent at a definite moment. In this context, the term “reservoir unit” is to be understood as being a partition of the supply reservoir element which is partitioned in chambers or the like.

As used herein, a “blister element” refers to a substantially hemispherical hollow element, accordingly having a circular opening which may be placed on a carrier plate or which may be covered with an appropriate covering film. The cavity of the hemispherical hollow element is suitable to be filled with liquid reagents. This requires an adequate choice of material to produce the blister elements, taking into consideration that the blister element has to be chemically inert with respect to the liquid reagents and that it must provide a definite flexibility with respect to the requirement of applying pressure onto it in order to drive the contained reagent when the blister is punched.

The present invention refers generally to a supply arrangement, the supply reservoir element being arranged above a fluidic device, wherein the supply reservoir element comprises one or more reservoir units. These reservoir units are preferably blister elements which are already filled with liquid reagents, in particular chemical reagents such as dyes or gels e.g. which are needed for protein separation. Filling of the reservoir units can be performed at any time before the reagents are used: Since the reagents are kept pure and since the reservoir units become tightly closed after filling, the reagents won't suffer a loss of quality. Therefore, the prefilling of the supply reservoir can be done after manufacturing of the supply reservoir units. After filling, the supply reservoir element becomes coupled permanently with a fluidic device, which device comprises one or more reception devices to receive the liquid reagents from the reservoir units when a fluidic communication between the supply reservoir element and the fluidic device is provided once.

In order to enable the liquid reagent to flow from the supply reservoir unit into a reception device, a puncturing element is provided within the arrangement. When operated, the puncturing element creates an opening in the film or plate on which the supply reservoir element is arranged, thus permitting the liquid to flow into the reception device.

The carrier plate of covering film can be made of a septum material or it can be made of aluminum. Other materials are possible as long as they fulfill the requirement of being chemically inert with respect to the reagents they are contacted with; they must furthermore close the blister elements tightly and they shall be easily penetratable.

Generally, a reservoir unit provided in a supply reservoir element needs to be paired with a reception device, being provided in the fluidic device in order to make sure that the desired volume of reagent flows via the reception device into the desired channel of the fluidic or microfluidic device or microfluidic chip, respectively.

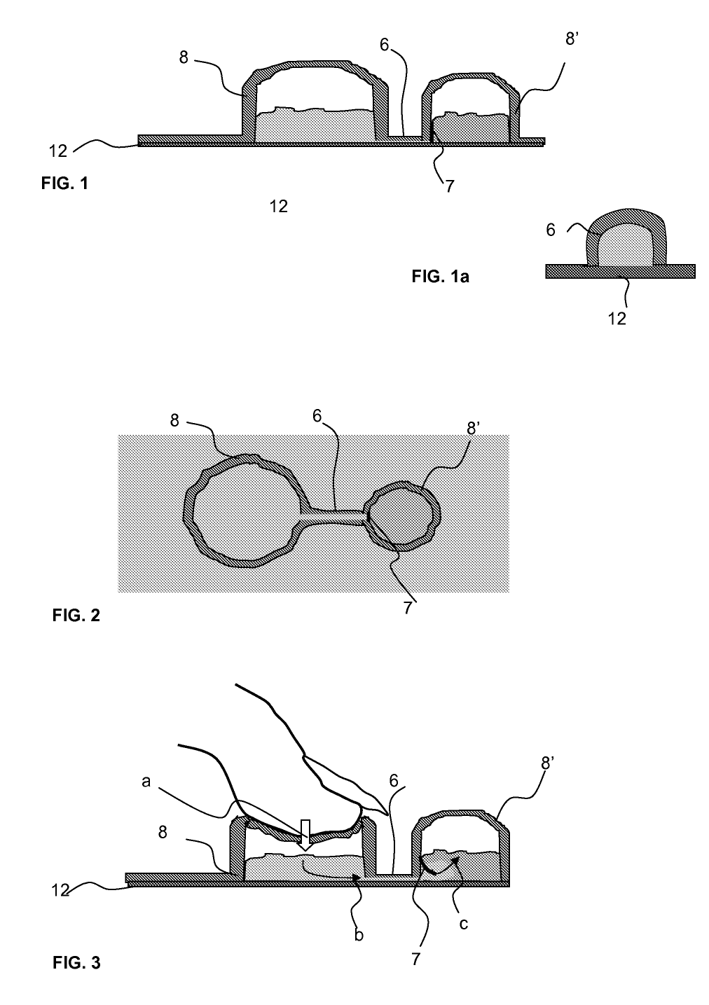

With reference to FIG. 1 a supply reservoir element 1 is shown. It comprises two blister elements 8,8′ serving as reservoir units. The blister elements 8,8′ have a hemispherical geometry in order to provide cavities suitable for being filled with a liquid reagent. They are arranged on a basal plane, which is a carrier plate 12 herein, but could as well be a foil, a covering film made of a polymeric material, or the like.

A passage links the first blister element 8, herein the bigger one, with the second blister element 8′, herein the smaller one, thus providing a fluidic communication between the both. In this embodiment the passage is designed as a channel 6 having an approximately cross sectional area 6′, as can be seen in FIG. 1a, but it could also be an element having another geometry than a channel has.

A liquid reagent fills the blister element 8′, and one can see that it stands in the channel 6, but can't flow into the second blister element 8′ due to a blocker, which blocks the channel 6. Herein a liquid proof membrane 7, which is arranged at the inside of the second blister element 8′, covering the cross sectional area 6′ serves as a blocker, as is pointed out by FIG. 2. Other suitable elements such as valves or blocking plates could serve as blocker, too.

Accordingly, mixing of the reagent being contained in the second blister element 8′ with the liquid fluid of the-blister element 8 can take place without a further operation, which is depicted in FIG. 3: When deblocking is desired, pressure is applied onto the blister element 8 by use of a finger, see arrow a. The increasing pressure inside the blister element 8 pressurizes the membrane 7 which is attached at the inside of the second blister element 8′, covering the cross sectional area 6′, and, due to the pressure, the membrane is detached (see arrow c) or just tears, and opens the channel. The reagent streams now from the first blister element 8 into the second blister element B′ according the indicated flow path, see arrow b, and the reagents start mixing. Subsequent pressurizing of the second blister element 8′ reverses the fluid flow and the mixing proceeds, resulting in a homogeneous mixed reagent after repeatedly alternating pressurizing of the both blister elements 8, 8′, carrying out a rocking movement with two fingers, for example.

Pressurizing might be performed manually or automatically. Furthermore, it is possible to link more than two blister elements 8, 8′ by channels 6 in order to provide a reagent mixture constituted of more than two initial reagents. The mixing process can be carried out in analogy to the mixing process as described above.

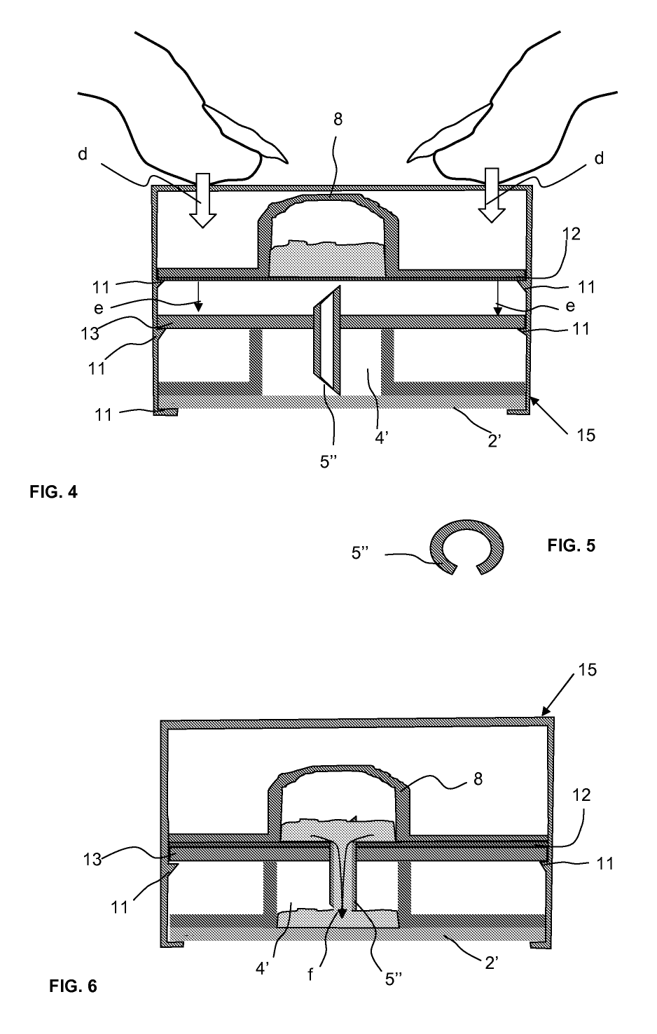

FIG. 4 shows a side view of a supply kit 15 comprising an arrangement of a microfluidic chip 2′ and a supply reservoir element 1 with a puncturing element including a cannula 5″ between them. The microfluidic chip 2′ provides a reception device 4, which is designed as a caddy 4′ herein.

The supply kit described by FIGS. 4 to 9 shows a single blister element 8 being paired with a single reception device, but it must be understood, that fluidic devices, in particular microfluidic chips have generally a plurality of reception devices, or caddies, respectively. Of course, the design of the basal plane of a supply reservoir unit is designed in accordance with the size of the microfluidic chip, in particular in accordance with the number of reception devices to be supplied with reagents; the topology of the microfluidic chip has to be respected.

Furthermore, it has to be taken into consideration that the plurality of reception devices requires the supply with different liquid reagents. Accordingly, a number of blister elements prefilled with the required reagents is arranged on the basal plane then, with the places of the blister elements being in accordance to the reception devices of the microfluidic device being arranged below.

The puncturing element 5 to be seen in FIG. 4 comprises a cannula 5″ which is tapered at both ends forming a sharp point. The cannula 5″ is placed in and held by a positioning plate 13 which is located in parallel between the fluidic device 2 and the carrier plate 12 of the reservoir element 1. The cannula 5″ is positioned normal with respect to the fluidic device 2, in points downwards into the caddy 4′ and rises above the positioning plate 13 into the blister element 8.

Additionally, FIG. 4 is focusing on the holding fixture 10, which has a number of removable spacing and holding elements 11. They provide a space between the supply reservoir element 1 and the microfluidic device 2′, with the supply reservoir element 1 being arranged above the microfluidic device 2′, while the holding elements 11 hold the supply arrangement in parallel within the holding fixture 10.

The holding fixture 10 prevents the supply arrangement from damage and provides additionally an easy handling, storing and transporting.

Generally, a holding fixture can be made of a polymeric material, it is substantially designed to incorporate the supply arrangement almost completely or at least partly, making sure that the components are held together, keep spaced one from the other in order to avoid an unforeseen operating of the puncturing element and prevent external influences.

The supply kits 15, 15′ comprise holding fixtures 10 made of flexible material, thus allowing to pressurize the blister element 8 indirectly, as shown in FIG. 8, or permitting application of pressure to the supply reservoir element 1 in order to settle it onto the microfluidic chip 2′, as FIG. 4 depicts.

In order to provide an easy and economic manufacturing of a holding fixture, the holding elements can at their inside be integrated in the inner wall. Then, they are preferably made of the same material as the holding fixture. But there may exist other possibilities to provide an appropriate holding fixture, with separately manufactured holding elements which become fixed inside the holding fixture by use of glue or other means.

Furthermore, the geometry of the holding elements may differ. The holding and spacing elements 11 shown in FIGS. 4, 6, 7, 8 are trigonal cubes which extend into the inside of the holding fixture 10 nose like, the basal plane seated on a number of “noses” with its edges. (This is not shown figuratively.)

The cannula 5″ of a preferred embodiment has a non-closed cross sectional profile, as is shown by FIG. 5, but it could as well be designed having a closed cross sectional profile, thus rather tube-like.

FIG. 6 depicts another side view of the supply kit of FIG. 4 with the puncturing element 5 being operated:

to perform operating, the supply reservoir element 1 and the microfluidic device arranged within the holding fixture 10 are brought together by use of pressure, thus performing pairing of the caddy 4′ with the blister element 8. This occurs due to the removing of the holding elements 11. They just break away, thus allowing the supply reservoir element 1 to settle directly downwards (see arrows e in FIG: 4) onto the microfluidic chip. This settling down is accompanied by puncturing of the carrier plate 12 by the cannula, thus the liquid reagent flows from the blister element 8 downwards into the caddy 4′, as indicated by the arrow f.

The supply kits 15, 15′ comprise holding fixtures 10 made of flexible material, thus permitting application of pressure to the supply reservoir element 1 in order to settle it onto the microfluidic chip 2′, as FIG. 4 depicts, or allowing to pressurize the blister element 8 indirectly, as shown in FIG. 8.

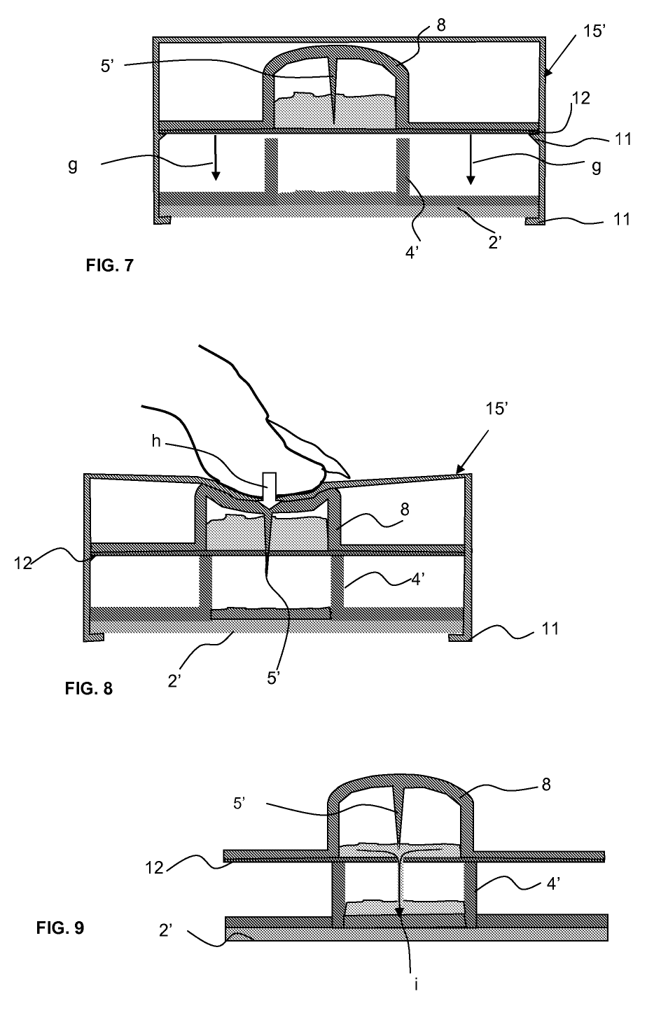

FIG. 7 shows the supply kit 15′, which differs from the supply kit 15 in particular with respect to the puncturing element 5, which is a punch needle 5′. The supply kit 15′ comprises a supply arrangement of supply reservoir element 1 and microfluidic chip 2′, too. The blister element 8 provided in this embodiment has additionally, a punch needle 5′ extending from the inner surface of the blister element 8 in direction to the carrier plate 12. Accordingly, a positioning plate 13 is not needed.

FIG. 8 depicts operating of the punch needle 5′:

to perform operating, the supply reservoir element 1 and the microfluidic device arranged within the holding fixture 10 are brought together by use of pressure, thus performing pairing of the caddy 4′ with the blister element 8. This happens since the holding elements 11 are removed; they just break away, thus allowing the supply reservoir element 1 to settle directly onto the microfluidic chip. The settling down, indicated by the arrows g in FIG. 7, is followed by pressing indirectly via the flexible holding fixture 10 onto the blister element (see arrow h) by use of a finger. The flexibility of the holding fixture 10 permits deformation, accordingly pressurization can be performed easily. Other embodiments might provide holding fixtures being only partially flexible. The punch needle 5′ penetrates the carrier plate 12 then, an opening is created and the liquid reagent is permitted to flow from the blister element 8 downwards into the caddy 4′, as indicated by the arrow i, see FIG.9

It must be understood, that the length of the cannula, punch needle or tube must be generally adopted to the depth of blister element and reception device. Additionally the needle must be designed in a way that no air bubbles are produced when the liquid reagent flows into the caddy or reception device; bubbles would hind the functioning of the microfluidic device.

The afore described invention is a very time saving device for daily chemist's and biochemist's lab work since those scientists, particularly when performing research in the field of proteomics or genomics need to spend a lot of time with preparation of fluidic devices. Dispensing reagents by use of pipettes or dispensing devices requires precise working, the handling of pipettes and dispensers is difficult. By use of the above invention readily filled supply kits are provided, ready to use. Processes requiring one way microfluidic chips are a perfect field for the application of said invention.

1. A supply arrangement comprising a supply reservoir element and a microfluidic device, wherein:
the supply reservoir element comprises a first reservoir unit having a prefilled liquid reagent therein,
the microfluidic device comprises a reception device adapted for receiving the liquid reagent from the first reservoir unit,
the supply reservoir element is coupled to the microfluidic device,
one of the supply reservoir element and the microfluidic device comprises a puncturing element in order to cause fluid flow of the liquid reagent from the first reservoir unit to the reception device when the puncturing element is operated, and
the supply reservoir element comprises a basal plane and the first reservoir unit comprises a first blister element arranged on the basal plane.

2. Supply arrangement according to claim 1, comprising at least one of the features:
the supply reservoir element is permanently coupled to the microfluidic device;
the puncturing element is arranged inside the supply arrangement;
the microfluidic device is a microfluidic chip.

3. Supply arrangement according to claim 1, further comprising a second reservoir unit having a second blister element, wherein the supply reservoir element comprises a passage between the first and a second blister elements providing a fluidic communication between the first and second reservoir units.

4. Supply arrangement according to claim 3, comprising a blocker adapted for blocking the passage to prevent the fluid flowing from the first blister element into the second blister element, and vice versa, until deblocking is desired.

5. Supply arrangement according to claim 4, comprising at least one of the features:
the passage is a channel having a cross sectional area;
the blocker is a liquid proof membrane, which is arranged at the inside of the first or the second blister element of the channel, covering the cross sectional area.

6. Supply arrangement according to claim 1, wherein the puncturing element comprises a cannula or a tube having at least one sharp end being held by a positioning plate being located in parallel between the microfluidic device and the basal plane of the reservoir element in a normal position with respect to the microfluidic device, pointing downwards into the reception device and rising above the positioning plate into the blister element, wherein the tube preferably has a non-closed cross sectional area profile.

7. Supply arrangement according to claim 1, comprising at least one of the features:
with the blister element and the basal plane having inner surfaces, wherein the puncturing element is a punch needle extending from the inner surface of the blister element in direction to the inner surface of the basal plane;
the liquid reagents are chemical reagents, in particular gels and dyes for biochemical applications;
the reception device is a caddy for supporting the microfluidic device; the basal plane is a carrier plate or a covering film.

8. A supply kit for the supply of a microfluidic device with a liquid reagent, comprising a supply reservoir element and a microfluidic device coupled in a supply arrangement, in particular a supply arrangement according to claim 1:
the supply arrangement is mounted in a holding fixture having one or more removable spacing and holding elements extending inwards, and the spacing and holding elements provide a space between the supply reservoir element and the microfluidic device and hold them substantially in parallel.

9. Supply kit according to claim 8, wherein the material of which the holding fixture is at least partially flexible.

10. A method for supplying a microfluidic device with a liquid reagent, comprising:
coupling a supply reservoir element, comprising a first reservoir unit having prefilled liquid reagent therein, with the microfluidic device comprising a reception device adapted for receiving the liquid reagent from the first reservoir unit,
performing pairing of the reception device with the first reservoir unit, and
operating a puncturing element to cause a fluid flow of the liquid reagent from the first reservoir unit to the reception device.

11. Method according to claim 10, wherein:
the supply arrangement is mounted in a holding fixture having one or more removable spacing and holding elements extending inwards, and the spacing and holding elements provide a space between the supply reservoir element and the microfluidic device and hold them substantially in parallel, and
coupling the supply reservoir element with the microfluidic device is performed by
settling the supply reservoir element onto the microfluidic device by use of pressure,
removing holding elements, preferably by breaking of the holding elements using pressure.

12. The method according to claim 10, comprising at least one of the features:
the puncturing element is operated by bringing the reservoir unit in contact with the reception device using pressure, the pressure is applied directly onto the reservoir element, or indirectly onto the holding fixture above the reservoir element, thus causing a downward movement of the reservoir element onto the microfluidic device, and a cannula or a puncher comprised in the puncturing element punctures a basal plane of the reservoir element and leads to a fluid flow from a blister element of the reservoir element downwards into the reception device;
the puncturing element is operated by applying pressure, either directly onto the blister element, or indirectly onto the holding fixture above the blister element, thus causing a downward movement of the a punch needle which punctures a basal plane of the reservoir element and leads to the fluid flow from a blister element of the reservoir element downwards into the reception device.

13. The method according to claim 10, wherein the supply reservoir element comprises reservoir units being blister elements having a passage between a first and a second blister element, comprising:
alternating applying pressure onto the first and the second blister elements in order to cause a fluid flow from the first blister element o into the second blister element, and vice versa, until a desired grade of mixing is achieved.

14. The method according to claim 13, comprising
using one or more fingers to apply the pressure,
alternating pressing the blister elements whereby a rocking movement is performed.
